(19) United States
(12) Patent Application Publication
(10) Pub. No.: US 2026/0140709 A1
(43) Pub. Date: May 21, 2026

(54) Dynamically Adaptable User Interface

(71) Applicant: Alfred Anthony Devivi, Fredericksburg, VA (US)

(72) Inventor: Alfred Anthony Devivi, Fredericksburg, VA (US)

(73) Assignee: United States of America, as represented by the Secretary of the Navy, Arlington, VA (US)

(21) Appl. No.: 18/953,252

(22) Filed: Nov. 20, 2024

(51) Int. Cl. G06F 8/34

(52) U.S. Cl. CPC G06F 8/34

(57) ABSTRACT

A computer-implemented method is provided for dynamically altering a user interface (UI) display by a computer-implemented method for altering a computer monitor display without recompilation of code. The method includes developing the UI display in FXML syntax that creates an FXML file. Data for display are mapped to particular fields in the UI display, within the FXML file. A JAVA Archive (JAR) file with the FXML file is deployed to a client device. The JAR file is executed with the FXML file to produce the UI display on the client device. The displays on the UI display are populated as defined by the FXML file.

### CROSS REFERENCE TO RELATED APPLICATION

Pursuant to 35 U.S.C. § 119, the benefit of priority from provisional application 62/873,290, with a filing date of Jul. 12, 2019, is claimed for this non-provisional application.

### STATEMENT OF GOVERNMENT INTEREST

The invention described was made in the performance of official duties by one or more employees of the Department of the Navy, and thus, the invention herein may be manufactured, used or licensed by or for the Government of the United States of America for governmental purposes without the payment of any royalties thereon or therefor.

### BACKGROUND

The invention relates generally to graphical user interfaces. In particular, the invention presents a method of dynamically adapting a user interface to changes in data type and content.

Most modern computing systems use some form of graphical user interface (GUI) or more commonly user interface (UI). Such UIs are compiled into program executables, and thus are not capable of adapting to changes in the input data without changes to the source. Modification of UIs requires additional development and delivery of executables which, in any complicated and mission critical system such as a combat system, will also require an extensive amount of testing (system, integration and regression) and certification along with all the associated activities and documentation. This can cause changing UI displays to be expensive and unresponsive to rapidly changing conditions and requirements.

Static UIs affect many industries and impact systems at many points over their life span. Military systems are more affected because of their inherent system of systems complexity, mission critical safety requirements and long service life. Early in a system life cycle, during prototype and development, changes can occur daily, if not hourly. Adapting UIs to changes in data types and structures can consume a significant amount of time and resources. As systems develop and move to integration with other systems, new interfaces and data requirements drive more changes to UI displays. Once fielded, it is not uncommon for a combat system to have a life span of thirty or more years and over that time the system will require many updates to adapt to new data, requirements, and conditions.

Dynamic user interfaces, or dynamic UIs, are portlets or pages that are dynamically created based on the definition of an existing page or portlet definition. A dynamic UI can be launched only by a portlet using the Dynamic UI Manager API. Because of its dynamic nature, the interface does not persist in the portal database and has a maximum lifetime of the operator's session with the portal. The interface can also be closed prior to the end of the session either programmatically or by the operator.

Internet portals can be created using HyperText Markup Language (HTML) or eXtensible Markup Language (XML). JavaFX employs a scriptable XML-based markup language called FXML for constructing Java based graphs. See http: //fxexperience.com/wp-content/uploads/2011/08/Introducing-FXML.pdf for more details. Java software was developed by Sun Microsystems and subsequently acquired by Oracle Technology Network.

Dynamic UIs are suited for applications in which operators might need to have several instances of a page or portlet open for multitasking. Consider the travel request scenario in business process integration as an example. If several marketing representatives need to travel to a conference, their manager would receive multiple travel requests. With static pages, the manager must complete one request before proceeding to the next one. Using dynamic UIs, the manager can open several requests simultaneously and navigate between these and other pages in the portal. Business process integration is an example of a dynamic UI configuration.

Dynamic pages and portlets contain many of the same properties as static pages and portlets. For example, the operator can navigate between static and dynamic pages, or change the window state of a dynamic portlet. However, dynamic UIs are not stored in the portal database, so they have less effect on server performance. Therefore, dynamic UIs cannot be administered. For example, one cannot view or update a dynamic page using Manage Pages or assign a unique name to a dynamic portlet or page.

A dynamic UI is independent of its point of origin. For example, if a portlet launches a dynamic page, the launched page is maintained even if the originating portlet or page is deleted. A dynamic UI is a copy of a page or portlet definition at the time the instance is created and is not affected by subsequent changes to the definition. By default, the dynamic UI acquires the title and description of its page or portlet definition. However, one can programmatically overwrite the title and description when the dynamic UI is launched.

As noted above, new interfaces and data requirements drive more changes to UI displays. Once fielded, it is not uncommon for a combat system to have a life span of thirty or more years, and over that time the system will require many updates to adapt to new data, requirements, and conditions. There remains a need to provide dynamic UIs that do not require the code to be e-compiled for every change to the UI.

### SUMMARY

Conventional user interfaces yield disadvantages addressed by various exemplary embodiments of the present invention. In particular, various exemplary embodiments provide a computer-implemented method for dynamically altering a user interface (UI) display by a computer-implemented method for altering a computer monitor display without recompilation of code. The method includes developing the UI display in FXML syntax that creates an FXML file. Data for display are mapped to particular fields in the UI display, within the FXML file. A JAVA Archive (JAR) file with the FXML file is deployed to a client device. The JAR file is executed with the FXML file to produce the UI display on the client device. The displays on the UI display are populated as defined by the FXML file.

### BRIEF DESCRIPTION OF THE DRAWINGS

These and various other features and aspects of various exemplary embodiments will be readily understood with reference to the following detailed description taken in conjunction with the accompanying drawings, in which like or similar numbers are used throughout, and in which:

FIG. 1 is a flow diagram view of a process for generating and deploying a user interface (UI) display;

FIG. 2 is a block diagram view for components in creating a dynamic UI display;

FIG. 3 is a timeline view for generating and deploying the dynamic UI display;

FIG. 4 is a flow diagram view for deploying the dynamic UI display;

FIG. 5 is a flow diagram view for deploying the dynamic UI display;

FIG. 6 is a flow diagram view for modifying the dynamic UI display;

FIGS. 7A and 7B are iconographic views of displayed files; and

FIG. 8 is a text view of an example JAR file;

FIGS. 9A and 9B are text views of an example CSS file;

FIG. 10 is a flow chart view of a procedure for implementing dynamic displays.

### DETAILED DESCRIPTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the present invention is defined only by the appended claims.

In accordance with a presently preferred embodiment of the present invention, the components, process steps, and/or data structures may be implemented using various types of operating systems, computing platforms, computer programs, and/or general purpose machines. In addition, artisans of ordinary skill will readily recognize that devices of a less general purpose nature, such as hardwired devices, may also be used without departing from the scope and spirit of the inventive concepts disclosed herewith. General purpose machines include devices that execute instruction code. A hardwired device may constitute an application specific integrated circuit (ASIC), a field programmable gate array (FPGA), digital signal processor (DSP) or other related component.

This disclosure relates to a framework that enables user interface (UI) data displays to be dynamically adapted to changes in data type and content without the need to recompile the executable software to create the display. According to the present disclosure, a base class performs base functionality for all UIs, such as providing infrastructure to host derived displays, an interface to a data store, and a thread to update fields in the UI. To accomplish this, a base file creates an anchor pane to host the derived elements for the UI display. The base class then loads a derived file that is provided. This derived file defines how the UI appears and which data are to be used by each UI component. The software then uses features of Java (an open source program) to load an instance of the object file. This provides flexibility for the UIs to adapt to changes in data location or selection.

Exemplary embodiments provide a framework that enables data displays called UIs to dynamically adapt to changes in data type and content, as well as evolving needs of operators, without the need to recompile the UI executable for displaying content on a hardware monitor. The dynamic UIs disclosed by this disclosure enable the addition and removal of data from the display by changing a specific file at runtime. The dynamic UIs enable many UIs having different features to be displayed using the same source code, simply by calling different files, without recompiling the software.

Exemplary embodiments provide a computer-implemented method, in which a UI display is developed in FXML syntax that creates an FXML file. Data for display are mapped to particular fields in the UI display, within the FXML file. A JAVA Archive (JAR) file with the FXML file is deployed to a client device. The JAR file is executed with the FXML file to produce the UI display on the client device. The displays on the UI display are populated as defined by the FXML file.

Exemplary computer-implemented methods herein provide for a base FXML file loaded to a processor. The base FXML file creates an anchor pane to host a user interface (UI) display. A derived FXML file is loaded to the processor. The derived FXML file defines how the UI display will appear and whichever data will be used by each component of the UI display. A Java ServiceLoader loads an instance of a ConfigurationInterface and PersistentMemoryInterface to the processor. Additionally, a cascading style sheet (CSS) file loads onto the processor to present the UI display to an operator based on a specified style sheet format. CSS is designed to enable the separation of presentation and content, including layout, colors and fonts incorporated in the UI display.

Exemplary computer-implemented methods provide a dynamic UI herein, a base class is created and executed. The base class performs base functionality for the UI. A derived class is created and executed. The derived class uses the Java language extension capability to build custom functionality for the UI.

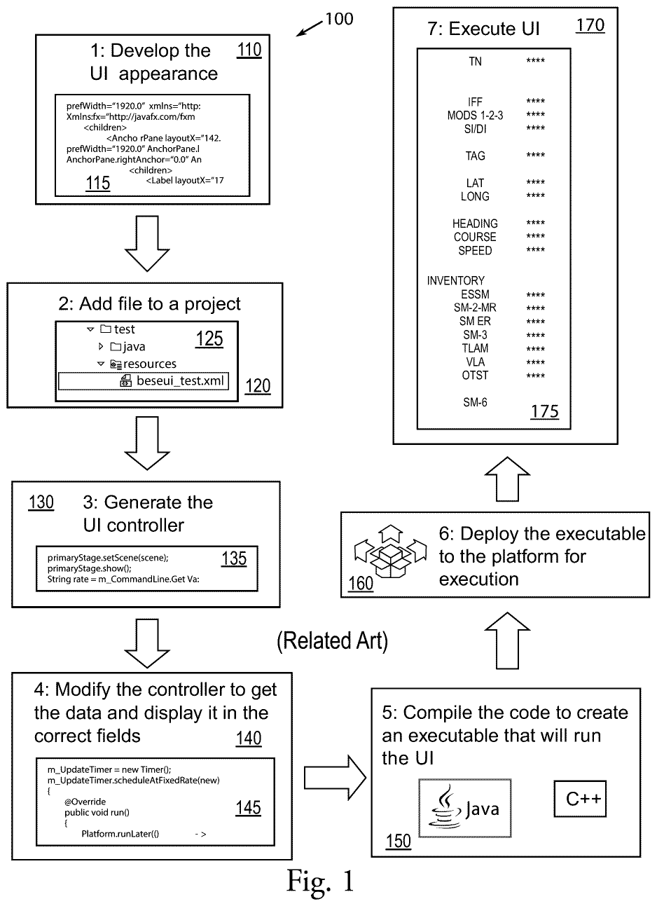

FIG. 1 shows a flow diagram view 100 illustrating the methodology for generating and deploying a user interface (UI) display according to related art. At a first step 110, the appearance of the UI is developed using an appropriate programming language, such as an eXtensible Markup Language (XML) to create an FXML file 115. Java is an object-oriented programming language that is portable, easy to program, and architecture-neutral. Object-oriented design focuses on the data, referred to as “objects” as well as the interfaces to the objects. The Java program is able to execute anywhere within a network including a variety of processing units and operating system architectures,

At a second step 120, the FXML file 115 is added to a project 125. At a third step 130, a UI controller 135 is generated using the same programming language. At a fourth step 140, the controller 135 may be modified as a code file 145 to obtain the data for display in correct fields. Then, at a fifth step 150, the code is compiled to create an executable command that produces the UI. Java programs are both compiled and interpreted. Compilation is performed once, and compiled Java programming code is called “Java ByteCode” (JBC) as an intermediate language that is architecture-neutral or platform-independent.

In this fifth step 150, a Java interpreter parses and runs JBC instructions on a processor. Interpretation occurs each time the program is executed. A Java binary file, referred to as a class file, includes the JBC for a given program as well as supporting information, such as symbolic data. A class file, or program file, includes “items” or information about the class, such as fields, methods, JBC arrays, and a symbolic reference table. Specifically, a Java program is composed of one or a set of Java files, which, on compilation, produce one or a set of class files.

At a sixth step 160, the executable command is deployed to the chosen platform for execution. JBC is effectively the machine code instructions for a “Java Virtual Machine” (Java VM). Every Java interpreter, such as a Java development tool or a Java-capable web browser uses an implementation of the Java VM. Often, these tools either use the Java VM already installed on a system, or may come bundled with a Java VM. Note that the Java VM may also be implemented in hardware. In this manner, the program may be compiled on any machine with a Java compiler and the resulting JBC may run on any implementation of the Java VM. At a seventh step 170, the executable command is executed to produce the UI display 175.

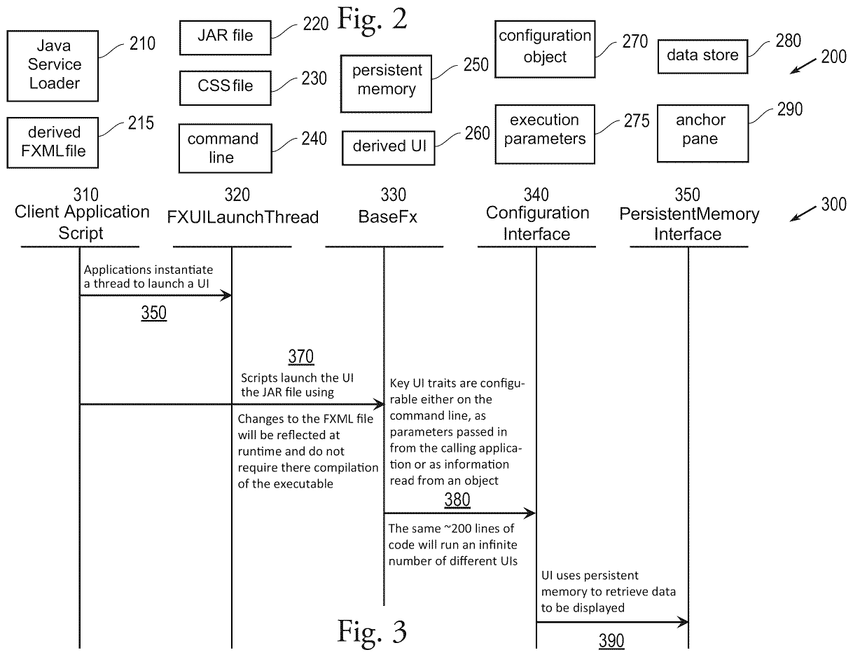

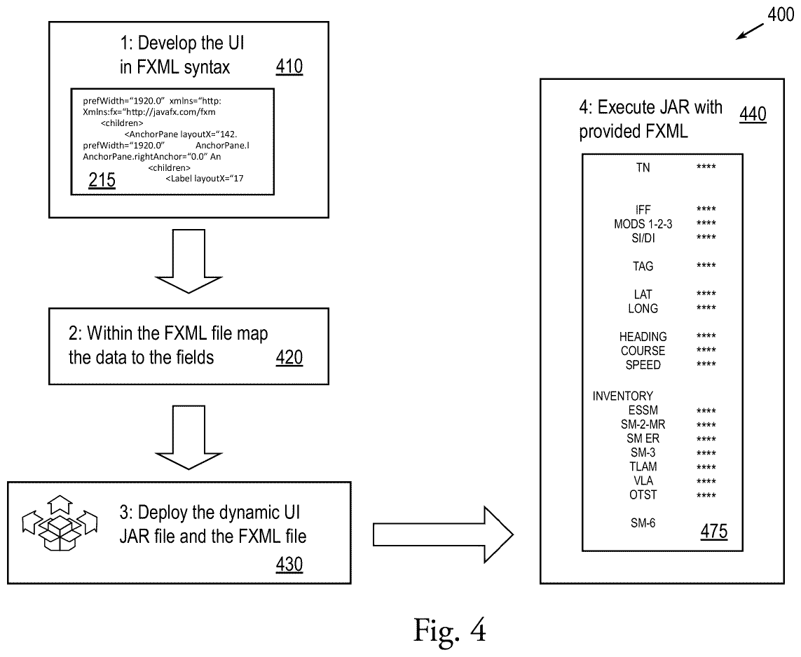

FIG. 2 shows a block diagram view 200 exemplary components related to dynamic UI creation. Java ServiceLoader 210, a derived FXML file 215. Select files for their creation: a Java ARchive (JAR) file 220, a CSS file 230, a command line 240, persistent memory 250 to produce derived UI display 260. Other file components include a configuration object 270 with execution parameters 275, data store 280, and an anchor pane 290.

FIG. 3 shows a timeline view 300 of dynamic UI creation. These dynamic UIs launch by threads via the command line 240, using a Client Application Script 310, or programmatically, using an FXUILaunchThread 320. Either way, the dynamic UI is provided with several resources including execution parameters 275 and a configuration object 270. There are two classes that are created and run the UI: the base class and the derived class. The base class, called BaseFX 330, performs base functionality for all UIs, such as providing infrastructure to host the derived UI display 260, the interface to the data store 280, and the thread to update the UI fields. The derived UI 260 can use the Java language extension capability to build custom functionality. Some UIs may not need custom functionality. In fact, many simple displays may use only the BaseFX 330 functionality to populate the UIs on the display defined by an FXML file 115.

The BaseFX 330 starts execution by loading a base FXML file 115, which creates the anchor pane 290 that the derived UI 260 will be hosted in. the BaseFX 330 then loads a derived FXML file 215, which defines how the UI appears and what data will be used by each UI component. The code then uses the Java ServiceLoader 210 (wrapped by the class InstanceLoader) to load in instance of the ConfigurationInterface 340 and the PersistentMemoryInterface 350. For example, a MySQL database may be the data source.

The data store 280 is runtime configurable and can be replaced by any custom functionality that conforms to the PersistentMemoryInterface 350. In a first launch thread 360, the Client Application Script 310 uses applications to instantiate the UI. In an alternate second launch thread 370, scripts from the FXUILaunchThread 320 use a JAR file 220 to instantiate the UI without recompiling the executable. In a loading thread 380, the BaseFX 330 then loads the proper CSS file 230 to present the UI to an operator based on the specified style sheet. Finally in the loading thread 380, the BaseFX 330 updates the UI either once or at a periodic rate as specified through parameters 275 in the command line 240 or the configuration object 270. The thread 380 updates each UI component based on the fx:id of the object 270, which contains the same name as the data from the database. A retrieval thread 390 pulls the data from the PersistentData object 270 are defined by an unseen “query” label in the derived FXML file 215. The data location is an agnostic store for data. Although conventional and commonly employed, the data location facilitates the exemplary process for an abstract interface as shown because it enables change in the data store without affecting the displayed UIs. This provides Dynamic UIs 260 flexibility to adapt to changes in data location or selection. In this manner, the same lines of code can be used to run an infinite number of different UIs depending on the FXML file 215.

FIG. 3 illustrates a flow diagram view 300 for a specific exemplary methodology for deploying a dynamic user interface display according to devices and methods herein. The UI 260 is developed 310 in an FXML file 215, using FXML syntax. This FXML file 215 may be similar to that shown in view 100. The data for display are mapped 320 to the particular fields within the FXML file 215. A BaseFX JAR file 220 created and deployed 330 is a package file format used to aggregate many Java class files and associated metadata and resources (text, images, etc.) into one file for distribution. The JAR file 220 is executed 340 with FXML to produce the UI display. In this manner, the data source of information to be displayed can be specified at runtime. Therefore, a client system can register with the monitor software. The client can send the FXML file 115 to the display monitor in which the FXML file 215 details the unique status objects for that system. Everything needed is contained in the FXML including the location of the data storage and the fields that are monitored. The display monitor merely needs to execute the BaseFX JAR file 220 and pass in the FXML file 215 to surface the client's status monitor UI.

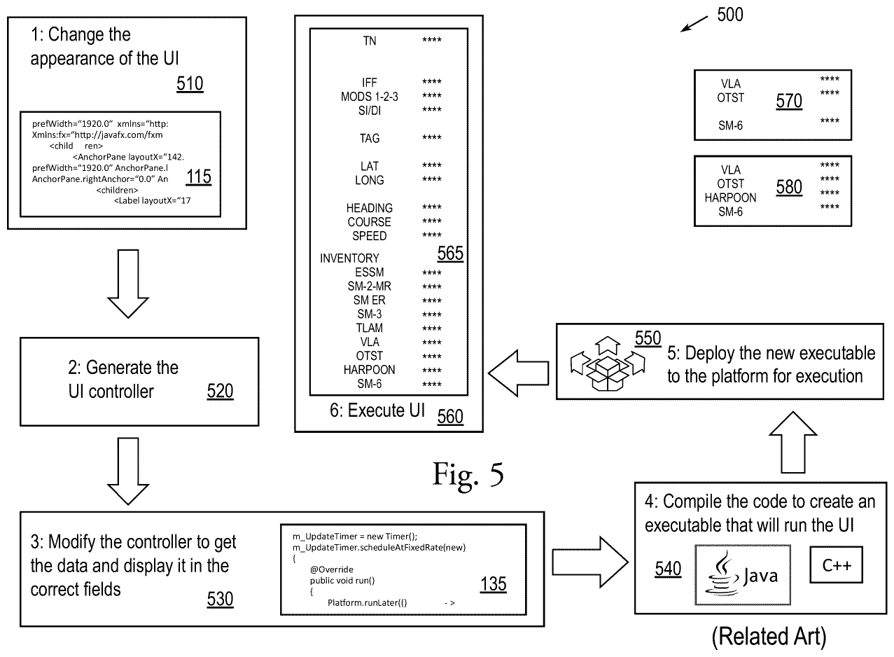

FIG. 5 shows a flow diagram view 500 illustrating the methodology for modifying a UI display from related art in contrast to the exemplary DynamicUIs function. In this example, a new device needs to be added to the UI display 175. Changing the appearance 510 begins with creating the FXML file 115 using the same programming language. The process proceeds to generating 520 and modifying 530 the UI controller 135 to obtain the data for display in correct fields. The process compiles 540 the code to create the executable command that will produce the UI. The process then deploys 550 the executable command for execution 560 to produce an altered UI display 565. Portions of the UI display are shown before modification 570 and after modification 580.

This process in view 500 is similar to the process described with reference to view 100. Note that in each case, the code must be compiled to create the executable command. This implementation can be any language (not only FXML) that develops the UI, e.g., MFC, Qt, etc. All these tools enable developing the UI, provide functionality through code and then run the resulting UI. Changes to the UI require changes to the code, recompile, redeliver. Changes to the data require the same for these conventional techniques. By contrast, exemplary DynamicUIs do not require a recompile in either of those cases.

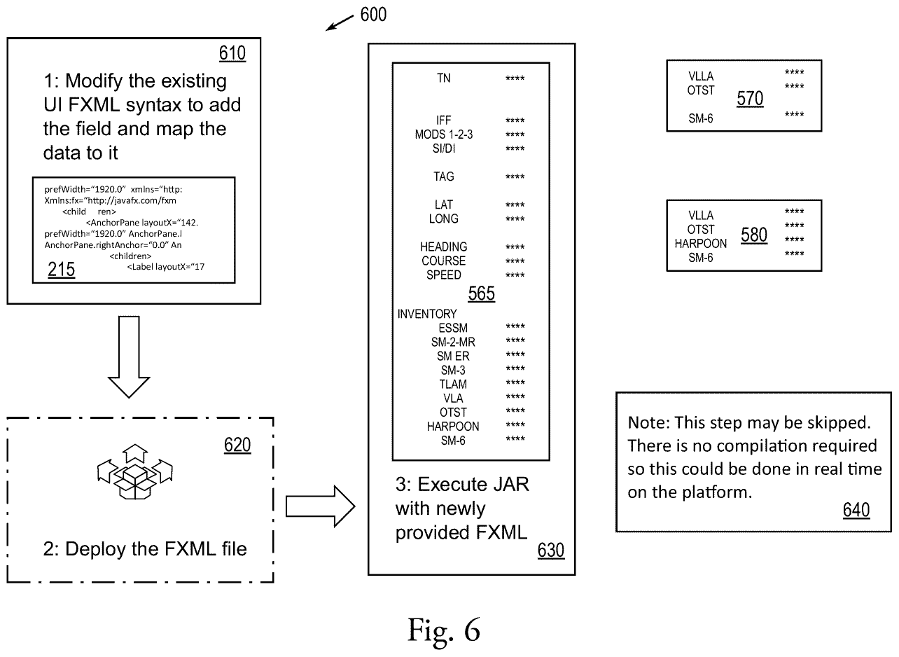

FIG. 6 shows an exemplary flow diagram view 600 illustrating a methodology for modifying a dynamic user interface display 260. As shown in view 500, a portion of the UI display before the change is shown at 570. The same portion of the UI display after modification is shown at 580. The modified UI is developed 610 in an FXML file 115 using FXML syntax. The process deploys 620 the FXML file 215. Changes to the FXML file 215 are reflected at runtime and do not require the recompilation 630 of the executable. Therefore, file deployment can be skipped 640 and, because there is no compilation required, this could be accomplished in real time on the platform. This means the JAR file 220 is executed 630 with FXML to produce the modified UI display 565.

In order to make applications written in Java portable, much symbolic information is maintained. During normal Java VM execution of the JBC, the Java VM uses the symbolic data to perform the dynamic binding whereby the actual pointer to the referenced structure is obtained. For example, each reference to a function is represented by the symbolic information: class name; function name; and signature. The class name identifies the class object containing the declaration of the method. The methods identify the various functions available for that class, and the JBC arrays are programs executed to implement a method. The function name, together with the signature, identifies the given function within its class. The signature describes the member and type of arguments passed to and returned by a function.

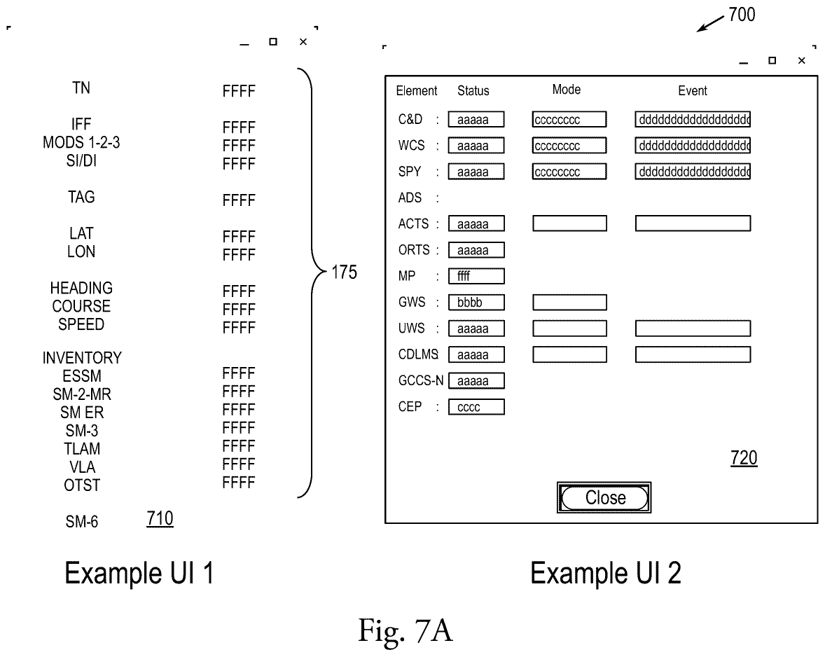

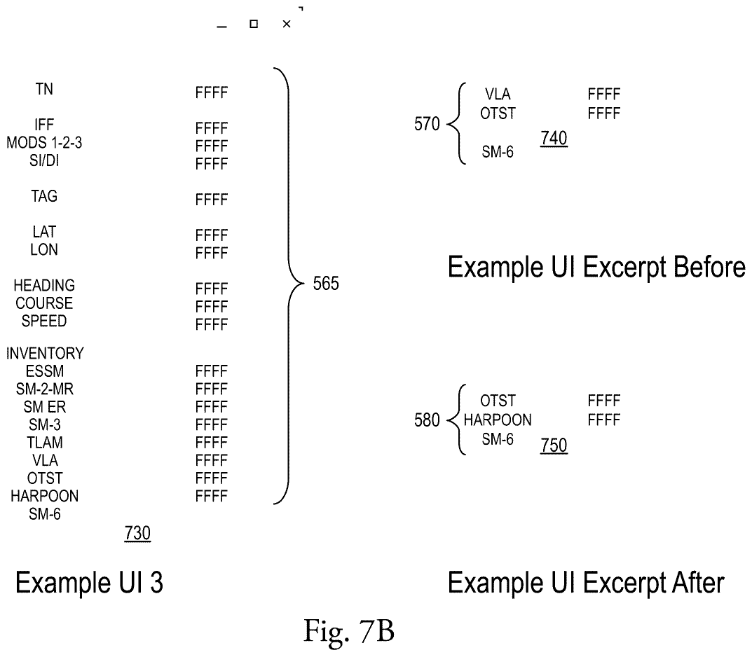

FIG. 7 is an iconographic view 700 of example files. A first UI example 710 denotes the unmodified display file 175. A second UI example 620 illustrates a dialog box display. A third UI example 730 denotes the modified display file 465. A fourth UI example 740 denotes the unmodified excerpt 570, while a fifth UI example 750 denotes the modified excerpt 580.

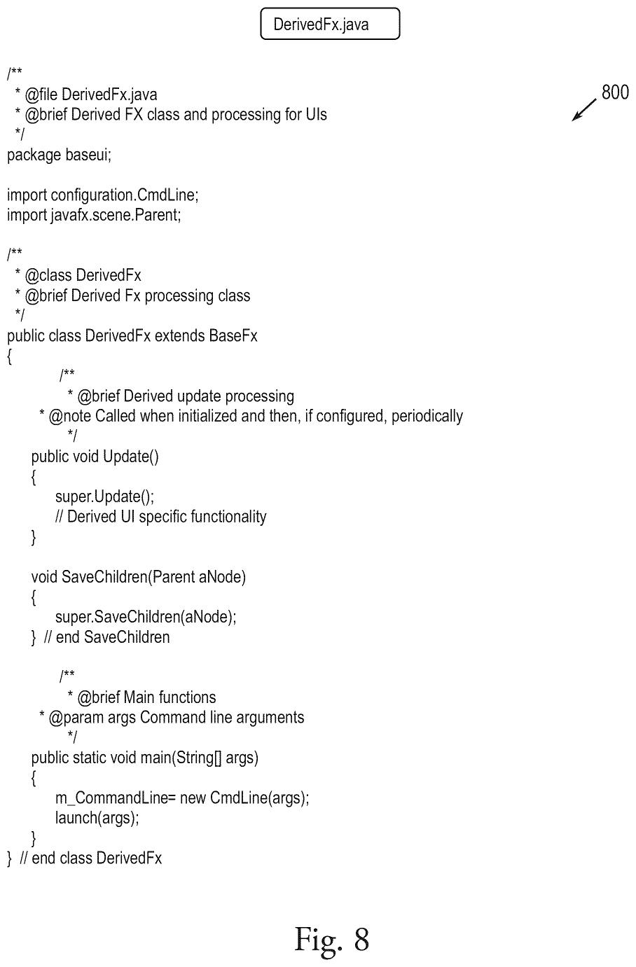

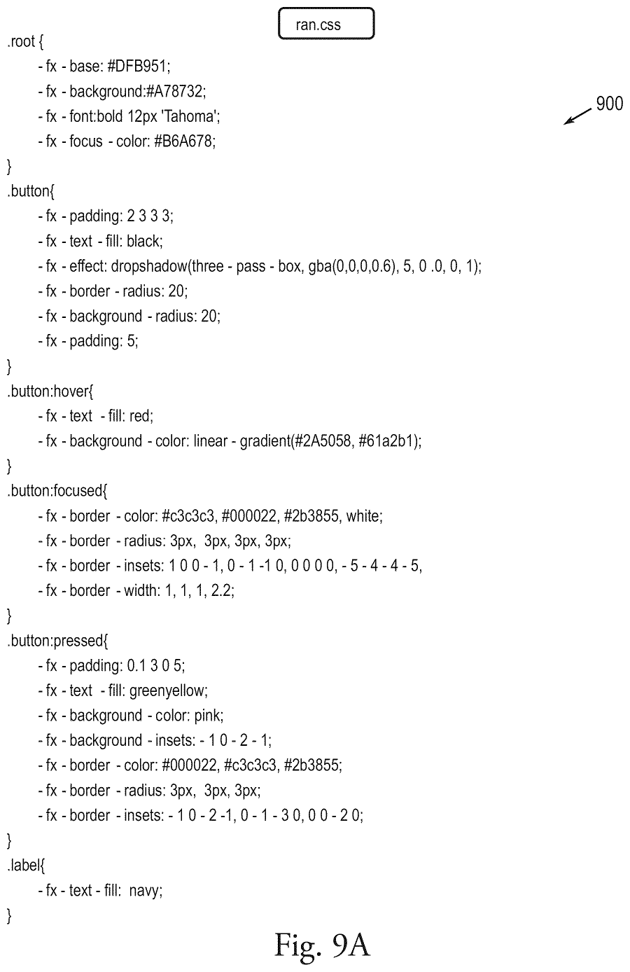

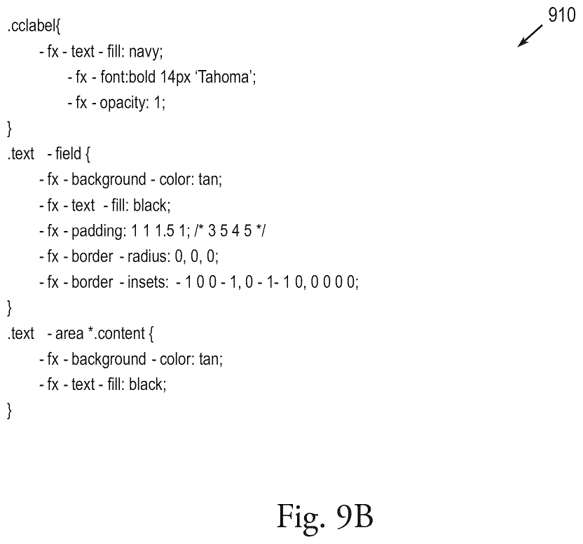

FIG. 8 is a text view 800 an example JAR file, in this case DerivedFx. java for the derived UI 260. FIGS. 9A and 9B are respective text views 900 and 910 of an example CSS file, for ran.css in this case. These views illustrate example syntax and instructions for altering display content and formats.

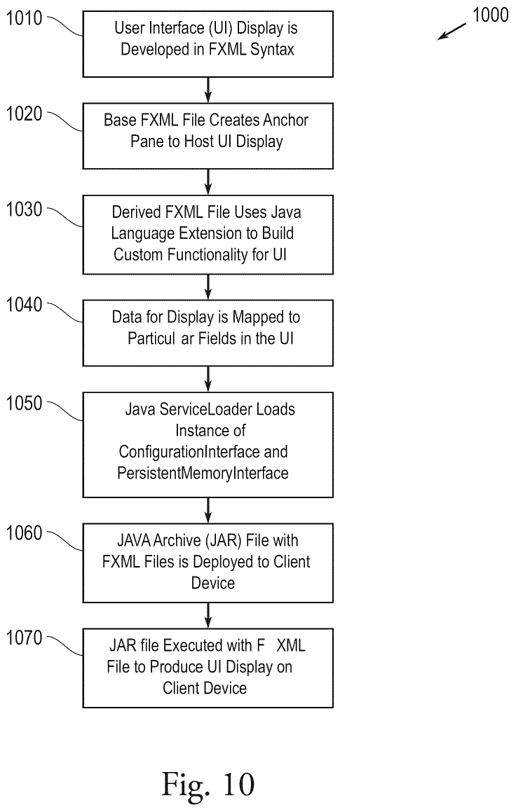

FIG. 10 is a flow chart view 1000 illustrating an exemplary process for a computer-implemented method. A user interface (UI) display is developed 1010 in FXML syntax that creates FXML files. A first FXML file 115 comprises a base FXML that performs base functionality for the UI. The base FXML file 115 creates 1020 an anchor pane 290 to host the UI display 565. A second FXML file 215 comprises a derived FXML file 215. Normally, there would only be two such FXML files 215. Only the BaseUI in the code base is used primarily because there is no need to derive extra functionality out of many of the displays. However, the functionality exists to derive from the base class, which enables the operator to take advantage of all the functionality, while still permitting them to customize specialized displays or fields within their UI. The derived FXML file 215 defines how the UI display 565 appears and which data are to be used by each component of the UI display 565.

The derived FXML file 215 uses the Java language extension capability to build custom functionality 1030 for the UI display. Data for display are mapped 1040 to particular fields in the UI display 565, within the derived FXML file 215. A Java ServiceLoader 210 loads 1050 an instance of a ConfigurationInterface 340 and PersistentMemoryInterface 350 to a processor. A JAVA Archive (JAR) file 220 with the FXML files 215 is deployed 1060 to a client device. The JAR file 220 is executed 1070 with the FXML file 215 to produce the image on the UI display 260 of the client device. The images on the UI display 565 are populated as defined by the FXML file 215.

Conventional UIs 175 are compiled-in static displays based on known and well defined data. Some of the advantages of the present disclosure enable Dynamic UIs 565 to enable the data source to be specified at runtime, which enables the displays to adapt dynamically to changes in those data structures. Dynamic UIs 565 also enable the addition and removal of data from the display by changing the FXML file 215 at runtime. Finally, dynamic UIs 565 permit many UIs to be displayed utilizing the same source code. Derived UI 260 is an extension of BaseUI, which enables the derived class to perform specific functions while taking advantage of the functionality in BaseUI from BaseFX 330. This is a technique to show that UIs are not restricted to only a single implementation, but can be extended to perform custom functionalities as needed.

These new capabilities provide many advantages for development and fielding of display UIs. Having a single code base confined to two source files, i.e., BaseFX 330 and Derived UI 260 simplifies an entire system while still enabling more complex behavior through derivation of the base class. This renders problem isolation and resolution much simpler and faster. This also facilitates understanding, creating and changing UIs to be drastically simpler, which has the effect of opening up operations to less experienced developers, thereby making the entire system cheaper to develop and maintain. The ability to adapt the display to changes in the underlying data can speed the development process by eliminating the need to change and compile the UI. Instead, a simple and rapid two-line change to a single file implements the change and the resources that would have been used on the UI can be redirected to other efforts.

Dynamic UIs can be an enabler of a Service Oriented Architecture (an SOA) in a more powerful manner by decoupling the need for a display system to know or depend on another system. Consider a monitoring system that maintains the status of all systems for a certain business or platform. As client systems register with the monitor software, a paradigm of SOA systems, the client can send the monitor the FXML file 215 detailing the unique status objects for that system. Everything needed is contained in that FXML file 215 including the location of the data storage and the fields that will be monitored. The monitor only needs to run the BaseFX JAR file 220 and pass in the FXML file 215 to surface the client's status monitor derived UI display 260.

The ability to easily and quickly manipulate the UI plays a role throughout the lifecycle of any system. As needs evolve, the system must change. These changes may be data oriented, in which the above capability will be critical. In instances where new data must be displayed, or old data removed, having the capability to accomplish those tasks quickly and easily can make the difference in whether or not the display changes become implemented. In a resource-constrained environment, it may not be feasible to investigate, implement, test, certify and deliver the change if it's too expensive or time consuming. Dynamic UIs make many UI changes simple and fast and can, in an unprecedented way, make changes possible directly on a platform while deployed.

The terminology used herein is for the purpose of describing particular systems and methods only and is not intended to be limiting of this disclosure. As used herein, singular articles are implied to include the plural forms as well, unless the context clearly indicates otherwise. It will be further understood that the verbs “comprises”, “comprising”, “includes”, and/or “including”, when used in this specification, specify the presence of stated features, integers, steps, operations, elements, and/or components, but do not preclude the presence or addition of at least one other feature, integer, step, operation, element, component, and/or group thereof. Further, the terms “automated” or “automatically” mean that once a process is started (by a machine or an operator), at least one machine performs the process without further input from any operator.

The corresponding structures, materials, acts, and equivalents of all means or step plus function elements in the claims below are intended to include any structure, material, or act for performing the function in combination with other claimed elements as specifically claimed. The descriptions of the various embodiments herein have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

While certain features of the embodiments of the invention have been illustrated as described herein, many modifications, substitutions, changes and equivalents will now occur to those skilled in the art. It is, therefore, to be understood that the appended claims are intended to cover all such modifications and changes as fall within the true spirit of the embodiments.

What is claimed is:

1. A computer-implemented method operating on a processor for dynamically modifying an image display on a computer monitor, said method comprising:
developing a user interface (UI) display in FXML syntax that creates an FXML file;
mapping data for display to particular fields in the UI display, within said FXML file;
deploying a JAVA Archive (JAR) file with said FXML file to a client device; and
executing said JAR file with the FXML files to produce the UI display on said client device, wherein
displays on the UI display are populated as defined by said FXML file.

2. The computer-implemented method according to claim 1, wherein said FXML files comprise:
a base FXML file; and
a derived FXML file.

3. The computer-implemented method according to claim 2, wherein said base FXML file performs base functionality for said user interface (UI) display.

4. The computer-implemented method according to claim 3, wherein said base FXML file creates an anchor pane to host said UI display.

5. The computer-implemented method according to claim 3, wherein said base FXML file provides an interface to a data store for said UI display.

6. The computer-implemented method according to claim 2, wherein said derived FXML file defines how the UI display will look and what data will be used by each component of said UI display.

7. The computer-implemented method according to claim 1, further comprising:
modifying said derived FXML file to change said display without recompiling said software file, responsive to changes being desired in said UI display.

8. A computer-implemented method operating on a processor for dynamically modifying a user interface (UI) display on a computer monitor, comprising:
loading a base FXML file to the processor;
loading a derived FXML file to the processor;
using a Java ServiceLoader to load an instance of a ConfigurationInterface and PersistentMemoryInterface to the processor; and
loading a CSS file to the processor to present the UI display to an operator based on a specified style sheet.

9. The computer-implemented method according to claim 8, wherein said base FXML file performs base functionality for the UI display.

10. The computer-implemented method according to claim 9, wherein said base FXML file creates an anchor pane to host the UI display.

11. The computer-implemented method according to claim 9, wherein said base FXML file provides an interface to a data store for the UI display.

12. The computer-implemented method according to claim 8, wherein said derived FXML file defines how the UI display will look and what data will be used by each component of the UI display.

13. The computer-implemented method according to claim 8, further comprising:
responsive to changes being desired in the UI display, modifying said derived FXML file to change said display without recompiling said software file.

14. A computer-implemented method of providing a dynamic user interface (UI), the method comprising:
creating and executing a base class, wherein said base class performs base functionality for the UI; and
creating and executing a derived class, wherein said derived class uses a Java language extension capability to build custom functionality for the UI.

15. The computer-implemented method according to claim 14, wherein said base class creates an anchor pane to host the UI.

16. The computer-implemented method according to claim 14, wherein said base class provides an interface to a data store for the UI.

17. The computer-implemented method according to claim 14, wherein said derived class defines how the UI will look and what data will be used by each component of the UI.

18. The computer-implemented method according to claim 14, further comprising:
responsive to changes being desired in the UI, modifying said derived class to change said display without recompiling said software file.
